(19) United States
(12) Patent Application Publication
(10) Pub. No.: US 2008/0047407 A1
(43) Pub. Date: Feb. 28, 2008

(54) XY ADJUSTMENT OF A BLADE OF A SLICER

(75) Inventor: Ralf-Peter Muller, Kempten (DE)

Correspondence Address: DOBRUSIN & THENNISCH PC, 29 W LAWRENCE ST, SUITE 210, PONTIAC, MI, 48342, US

(73) Assignee: CFS Buhl

(21) Appl. No.: 11/836,329

(22) Filed: Aug. 9, 2007

(30) Foreign Application Priority Data
Aug. 11, 2006 (DE) 102006037856.3

(51) Int. Cl. B26D 7/26

(52) U.S. Cl. 83/34; 83/508.2

(57) ABSTRACT

The present invention relates to a device for slicing food product blocks, having a machine frame, a product feed system with a cutting edge provided at the end and a s cutting head housing with a rotationally driven blade, which rotates in a cutting plane determined by the cutting edge and comprises a bearing arrangement, an adjusting means being provided, by means of which the position of the cutting circle of the blade is adjustable relative to the cutting edge within the cutting plane defined by the x- and y-coordinates and the cutting head housing is adjustable in the y-direction relative to the machine frame, said device displaying adjustment which adjusts the bearing arrangement of the blade in the x-direction relative to the cutting head housing.

The present invention relates to a device for slicing food product blocks, having a machine frame, a product feed system with a cutting edge provided at the end and a cutting head housing with a rotationally driven blade, which rotates in a cutting plane determined by the cutting edge and comprises a bearing arrangement, an adjusting means being provided, by means of which the position of the cutting circle of the blade is adjustable relative to the cutting edge within the cutting plane defined by the x- and y-coordinates and the cutting head housing is adjustable in the y-direction relative to the machine frame.

Generic devices for slicing food product blocks are known from the prior art, for example EP 1 432 556 D1. This European Patent teaches a device for slicing food products in which the cutting head housing is adjusted in the x- and y-directions. However, this device has the disadvantage that there are only limited possibilities for arranging other units, such as for example traction belts, on this housing as a result of the adjustment of the cutting head housing in the x-direction.

The object of the present invention is accordingly to provide a device for slicing food product blocks which does not exhibit the disadvantages of the prior art.

The object is achieved according to the invention with a device for slicing food product blocks, having a machine frame, a product feed system with a cutting edge provided at the end and a cutting head housing with a rotationally driven blade, which rotates in a cutting plane determined by the cutting edge and comprises a bearing arrangement, an adjusting means being provided, by means of which the position of the cutting circle of the blade is adjustable relative to the cutting edge within the cutting plane defined by the x- and y-coordinates and the cutting head housing is adjustable in the y-direction relative to the machine frame, said device displaying adjustment which adjusts the bearing arrangement of the blade in the x-direction relative to the cutting head housing.

It was extremely surprising and unexpected for a person skilled in the art that it should be possible, with the machine according to the invention, to arrange units such as traction belts for example on the cutting head housing, although the device according to the invention allows adjustment of the trajectory of the blade in the x/y direction.

According to the invention, the device according to the invention allows adjustment of the cutting circle of the blade within the cutting plane defined by x/y coordinates, wherein the cutting head housing is adjusted in the y-direction relative to the machine frame. Adjustment of the cutting circle of the blade in the x-direction proceeds according to the invention by adjustment of the bearing arrangement of the blade relative to the cutting head housing; i.e. with the device according to the invention only the bearing arrangement of the blade, but not the cutting head housing itself, is adjusted in the x-direction.

Preferably, adjustment of the bearing arrangement of the blade in the x-direction takes place along a linear guide. Such a linear guide may for example be a dovetail guide, along which the blade is displaced.

In another preferred embodiment, adjustment of the blade in the x-direction takes place along a circular path.

In both cases, the blade is preferably driven by a flexible drive, for example a toothed belt drive, which may follow the movement of the blade or the drive shaft thereof.

Preferably, the device according to the invention comprises a rotor, which is displaceable in the x-direction relative to the cutting head housing. The blade is attached to this rotor.

Since, with the device according to the invention, the blade and/or the drive thereof is displaced in the x-direction relative to the cutting head housing, the latter has to comprise an opening for movement for example of the blade shaft. This opening is preferably closed by a cover, which particularly preferably moves together with the blade and/or the drive thereof.

Preferably, the device according to the invention comprises traction belts, which convey the food product block to the blade; preferably these traction belts are arranged on the cutting head housing and may particularly preferably be displaced together therewith in the y-direction.

In a further preferred embodiment of the present invention, the product feed system comprises a gripper, which engages in the end of the food product block remote from the cutting blade and conveys said block in the direction of the cutting blade. Particularly preferably, this gripper is likewise displaceable with the cutting head housing in the y-direction.

According to a further aspect of the present invention or according to a preferred embodiment of the above-stated invention, the device comprises a means with which the cutting blade may be moved out of the cutting plane parallel to the drive axis of the blade to bring about empty cuts. Particularly preferably, this means is adjusted in the x- and y-directions together with the cutting circle of the blade.

According to another aspect of the present invention or according to a preferred embodiment of the two above-stated inventions, the device comprises a sensor means, preferably a camera, which tracks the cutting process. As a function of the signal of this sensor means, adjustment of the cutting circle takes place in the x- and/or y-directions, but in particular in the x-direction. This preferred embodiment of the present invention is advantageous in particular with regard to portion formation, in particular because the position of the blade in the x-direction influences the trajectory of the cut-off food product slice, which is of significance for portion formation.

According to an additional aspect of the present invention or a preferred embodiment of the above-stated inventions, a further machine parameter is automatically adapted in the x- and/or y-direction as a function of adjustment of the cutting circle of the blade.

Preferably, the position of the mouthpiece is automatically adapted to the new x- and/or y-position, in particular the x-position, of the cutting circle of the blade.

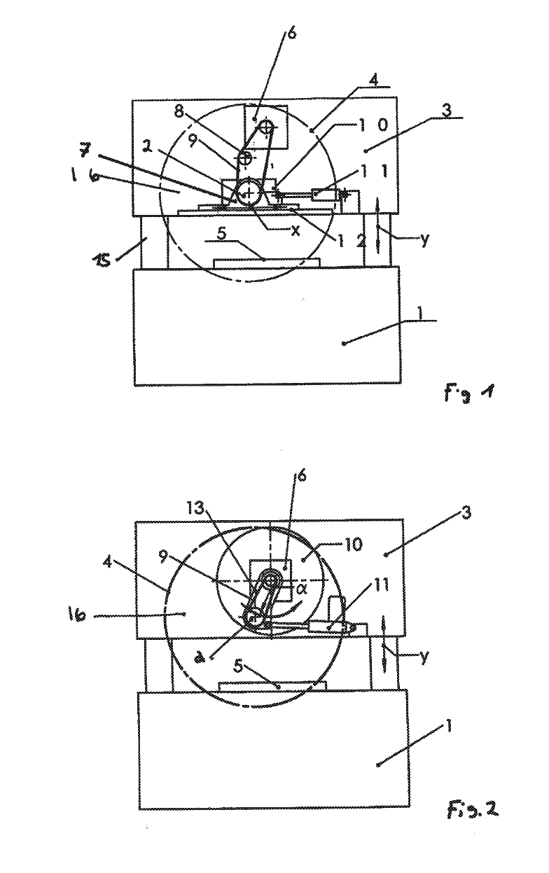

The invention is explained below with reference to FIGS. 1 to 3.

These explanations are given merely by way of example and do not restrict the general concept of the invention. These explanations apply equally to all the subject matters of the invention.

According to a further aspect of the present invention or according to a preferred subject matter of the above-stated invention, automatic setting of the cutting circle of the blade in the x- and/or y-direction takes place on the basis of determination of product parameters, such as for example temperature, density and dimensions before and/or during the cutting process.

FIG. 1 shows an embodiment of the device according to the invention.

FIG. 2 shows a further embodiment of the device according to the invention.

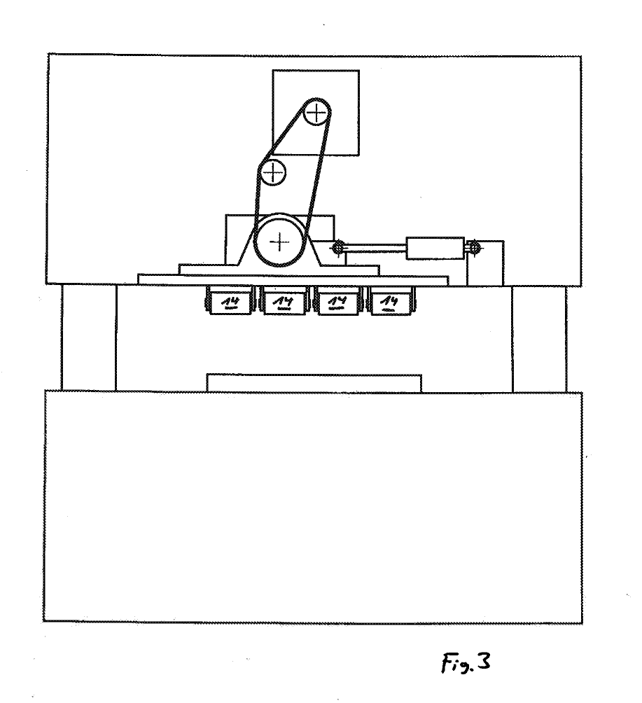

FIG. 3 shows the device according to the invention according to FIG. 1 with associated traction belts.

FIG. 1 shows an embodiment of the device according to the invention, which comprises a machine frame 1. The cutting head housing 3 is adjustable in the y-direction relative to this machine frame along the guides 15. The drive shaft 2 of the blade and/or of a rotor is arranged in the cutting head housing 3. This shaft 2 or the blade, which has a cutting circle 4, is moved in the x-direction along the dovetail guide 12 by means of the adjusting mechanism 11. The adjusting mechanism may be a linear motor, which comprises a sensor, such that control of the device according to the invention knows the position of the blade at each point in time. The shaft 2 is driven by the toothed belt 9, which is arranged between the motor 6 and the shaft 2. The toothed belt is tensionable by means of the tensioning roller, such that it always has the same tension irrespective of the position of the shaft 2 in the x-direction. It is clear that in the present case the cutting head housing 3 is not moved in the x-direction, but rather merely the shaft 7 of the blade. Therefore, the cutting head housing 3 has to comprise an opening, through which the shaft 2 projects. This opening is covered by a cover 10, which moves together with the shaft 2.

FIG. 2 shows a further embodiment of displacement of the blade shaft 2 in the x-direction. This is arranged in the present case on the swivel lever 13, which, as indicated by the double-headed arrows, may be displaced along a circular path. The s swivel lever 13 is driven by the adjusting mechanism 11. The cutting circle is adjusted in the x-direction by the swivel lever 13 and the adjusting mechanism 11. Once adjustment in the x-direction has taken place, corresponding adaptation in the y-direction has to take place through raising or lowering of the cutting head housing. Reference is otherwise made to the explanations relating to FIG. 1.

FIG. 3 shows the device according to FIG. 1. In the present case, four traction belts 14 are arranged on the cutting head housing, said belts being capable of adjustment in the y-direction jointly with the cutting head housing. Four food product blocks are conveyed in the direction of the cutting blade using the traction belts.

The traction belts should in practice be located as far as possible centrally over the products, for which reason attachment to the cutting head housing fixed in the x-direction constitutes a significant advantage of the invention.

### LIST OF REFERENCE NUMERALS

1 Machine frame
2 Drive shaft
3 Cutting head housing
4 Trajectory of the blade
5 Cutting edge
6 Motor
7 Bearing arrangement of the shaft of the blade or of the rotor
8 Tensioning roller
9 Toothed belt
10 Cover for the opening in the cutting head housing
11 Adjusting unit, electromotively driven linear drive
12 Linear guide, dovetail guide
13 Swivel lever
14 Traction belts
15 Vertical guide of the cutting head housing

1-12. (canceled)

13. A device for slicing food product blocks, comprising a machine frame, a product feed system with a cutting edge provided at an end and a cutting head housing with a rotationally driven blade, which rotates in a cutting plane determined by the cutting edge and comprises a bearing arrangement, wherein:
an adjusting means is provided, by means of which the position of the cutting circle of the blade is adjustable relative to the cutting edge within the cutting plane defined by x- and y-coordinates, and the cutting head housing is adjustable in the y-direction relative to the machine frame, and
the displacement adjustment of the device configured for adjusting the bearing arrangement of the blade in the x-direction relative to the cutting head housing.

14. The device of claim 1, wherein adjustment of the bearing arrangement of the blade in the x-direction takes place along a linear guide.

15. The device of claim 1, wherein adjustment of the bearing arrangement in the x-direction takes place along a circular path.

16. The device of claim 1, further comprising a rotor, which is displaceable in the x-direction relative to the cutting head housing.

17. The device of claim 4, wherein the product feed system comprises a traction belt, which is arranged on the cutting head housing.

18. The device of claim 5, wherein the traction belt is displaceable in the y-direction jointly with the cutting head housing.

19. The device of claim 1, wherein the product feed system comprises a gripper, which is displaceable in the y-direction jointly with the cutting head housing.

20. The device of claim 5, wherein the product feed system comprises a gripper, which is displaceable in the y-direction jointly with the cutting head housing.

21. The device of claim 1, further comprising a means with which the cutting blade is movable out of the cutting plane parallel to the drive axis to bring about empty cuts, the means being adjustable in the x-direction, the y-direction, or jointly with the cutting circle of the blade.

22. The device of claim 5, further comprising a means with which the cutting blade is movable out of the cutting plane parallel to the drive axis to bring about empty cuts, the means being adjustable in the x-direction, the y-direction, or jointly with the cutting circle of the blade.

23. The device of claim 8, further comprising a means with which the cutting blade is movable out of the cutting plane parallel to the drive axis to bring about empty cuts, the means being adjustable in the x-direction, the y-direction, or jointly with the cutting circle of the blade.

24. The device of claim 1, further comprising a sensor means that includes a camera, which tracks the cutting process, and wherein adjustment of the cutting circle in the x-direction, the y-direction, or both takes place as a function of a signal from the sensor means.

25. The device of claim 7, further comprising a sensor means that includes a camera, which tracks the cutting process, and wherein adjustment of the cutting circle in the x-direction, the y-direction, or both takes place as a function of a signal from the sensor means.

26. The device of claim 9, further comprising a sensor means that includes a camera, which tracks the cutting process, and wherein adjustment of the cutting circle in the x-direction, the y-direction, or both takes place as a function of a signal from the sensor means.

27. The device of claim 1, wherein one or more machine parameters are automatically adapted as a function of adjustment of the cutting circle in the x-direction, the y-direction, or both.

28. The device of claim 15, further comprising a mouthpiece that is movable is accommodate for adjustment of the cutting circle of the blade.

29. The device of claim 1, wherein at least one automatic setting of the cutting circle of the blade in the x-direction, the y-direction, or both takes place on the basis of determination of product parameters that include temperature, density, dimensions before the cutting process, during the cutting process, or both, or any combination thereof.

30. The device of claim 13, wherein at least one automatic setting of the cutting circle of the blade in the x-direction, the y-direction, or both takes place on the basis of determination of product parameters that include temperature, density, dimensions before the cutting process, during the cutting process, or both, or any combination thereof.

31. A device for slicing food product blocks, comprising a machine frame, a product feed system with a cutting edge provided at an end, a cutting head housing with a rotationally driven blade, which rotates in a cutting plane determined by the cutting edge and comprises a bearing arrangement, a rotor, which is displaceable in the x-direction relative to the cutting head housing, a means with which the cutting blade may be moved out of the cutting plane parallel to the drive axis to bring about empty cuts, the means being adjustable in the x-direction, the y-direction, or jointly with the cutting circle of the blade, and a sensor means that includes a camera, which tracks the cutting process, and wherein adjustment of the cutting circle in the x-direction, the y-direction, or both takes place as a function of a signal from the sensor means, wherein:
an adjusting means is provided, by means of which the position of the cutting circle of the blade is adjustable relative to the cutting edge within the cutting plane defined by x- and y-coordinates;
the cutting head housing is adjustable in the y-direction relative to the machine frame;
the displacement adjustment of the device configured for adjusting the bearing arrangement of the blade in the x-direction relative to the cutting head housing,
the adjustment of the bearing arrangement of the blade in the x-direction takes place along a linear guide or a circular path;
the product feed system comprises a traction belt, which is arranged on the cutting head housing and is displaceable in the y-direction jointly with the cutting head housing, and a gripper, which is displaceable in the y-direction jointly with the cutting head housing;
one or more machine parameters are automatically adapted as a function of adjustment of the cutting circle in the x-direction, the y-direction, or both such that the position of a mouthpiece is changed, and
at least one automatic setting of the cutting circle of the blade in the x-direction, the y-direction, or both takes place on the basis of determination of product parameters that include temperature, density, dimensions before the cutting process, during the cutting process, or both, or any combination thereof.

32. A method for slicing food product blocks, comprising the steps of:
providing:
a machine frame;
a product feed system with a cutting edge provided at an end, the product feed system comprises a traction belt, which is arranged on the cutting head housing;
a cutting head housing with a rotationally driven blade, which rotates in a cutting plane determined by the cutting edge and comprises a bearing arrangement; and
a rotor, which is displaceable in the x-direction relative to the cutting head housing;
adjusting the position of the cutting circle of the blade relative to the cutting edge within the cutting plane defined by x- and y-coordinates, the cutting head housing in the y-direction relative to the machine frame, or both, the displacement adjustment of the device configured for adjusting the bearing arrangement of the blade in the x-direction relative to the cutting head housing;
moving the cutting blade out of the cutting plane parallel to the drive axis to bring about empty cuts, the cutting blade being adjustable in the x-direction, the y-direction, or jointly with the cutting circle of the blade;
feeding the food product blocks along the traction belt of the product feed system;
cutting the food product blocks; and
tracking the cutting process by way of a sensor that includes a camera, wherein the cutting circle adjusts in the x-direction, the y-direction, or both as a function of a signal from the sensor.
